(19) United States
(12) Patent Application Publication
(10) Pub. No.: US 2026/0049240 A1
(43) Pub. Date: Feb. 19, 2026

(54) MODIFIED BASE OILS FOR HEAT TRANSFER FLUIDS

(71) Applicant: VGP IPCO LLC, Lexington, KY (US)

(72) Inventors: Jesse Dambacher, Lexington, KY (US); Jayesh Shimpi, Navapur (IN); Keshav Badhe, Mumbai (IN); Rajkumar Rajule, Kalyan(W) (IN); Roger Dale England, Oak Ridge, TN (US)

(21) Appl. No.: 19/298,751

(22) Filed: Aug. 13, 2025

Related U.S. Application Data
(60) Provisional application No. 63/682,873, filed on Aug. 14, 2024.

(51) Int. Cl. C09K 5/10; C10G 55/06

(52) U.S. Cl. CPC C09K 5/10; C10G 55/06; C10G 2300/1062; C10G 2300/4006; C10G 2400/10

(57) ABSTRACT

This invention allows for an underutilized hydrocarbon fluid such as typical Group 1 base stocks to be altered to increase its thermal conductivity and employed as dielectric coolants.

### CROSS REFERENCE TO RELATED APPLICATIONS

This application claims priority to U.S. Provisional Application No. 63/682,873, filed Aug. 14, 2024, the entire contents of which are incorporated herein by reference.

### TECHNICAL FIELD

This disclosure relates to base oils for heat transfer fluids or immersion coolants useful in the thermal management of electrical systems and electrical power generation systems.

### BACKGROUND

Dielectric fluids for immersion heat transfer are used to cool high performance computers as traditional air-cooled methods are unable to remove enough heat. Submerging computers or servers in a fluid as a means of removing heat is more efficient, but the fluid must be very inert and very dielectric. Ability to remove heat is its thermal conductivity. The most common fluids used in immersion cooling with high thermal conductivity are traditionally esters or polyalphaolefins.

### SUMMARY

The Summary is provided to introduce a selection of concepts that are further described below in the Detailed Description. This Summary is not intended to identify key or essential features of the claimed subject matter, nor is it intended to be used as an aid in limiting the scope of the claimed subject matter.

This invention allows for an underutilized hydrocarbon fluid such as typical Group 1 base stocks to be altered to increase its thermal conductivity and employed as dielectric coolants.

Other methods, features and/or advantages is, or will become, apparent upon examination of the following figures and detailed description. It is intended that all such additional methods, features, and advantages be included within this description and are protected by the accompanying claims.

### BRIEF DESCRIPTION OF DRAWINGS

FIG. 1 is a schematic diagram of a fixed-bed reactor.

FIG. 2 is ¹H NMR of Group I Base oil (Aramco Dura 150).

FIG. 3 is ¹³C NMR of Group I Base oil (Aramco Dura 150).

FIG. 4 is ¹H NMR of Exp.1 (Oxidation of Aramco dura 150 using CuO as a catalyst).

FIG. 5 is ¹³C NMR of Exp.1 (Oxidation of Aramco dura 150 using CuO as a catalyst)

### DETAILED DESCRIPTION

Lubricant esters and polyalphaolefin (PAO) fluids have very high thermal conductivities which makes them useful as immersion coolants. Hydrocarbon fluids such as Group I base oils are not used as immersion coolants because they have lower thermal conductivity than esters and PAO. Improving the thermal properties of Group I base oils can allow it to have similar properties as esters and PAO to allow use as immersion coolants.

This invention is to chemically alter a Group I base oil by adding ketones or alcohol groups to aromatics present in the base oil, thereby increasing the thermal conductivity more like that of esters or PAO. Friedel-Crafts acylation or alkylation is one of several methods that can be used to modify Group I base oils to increase thermal conductivity. This invention allows for an underutilized hydrocarbon fluid such as typical Group 1 base stocks to be altered to increase its thermal conductivity and employed as dielectric coolants.

### Definitions

Unless otherwise defined, all technical and scientific terms used herein have the same meaning as commonly understood by one of ordinary skill in the art to which this invention pertains. In case of conflict, the present specification, including definitions, will control.

Unless otherwise specified, “a,” “an,” “the,” “one or more of,” and “at least one” are used interchangeably. The singular forms “a”, “an,” and “the” are inclusive of their plural forms.

The recitations of numerical ranges by endpoints include all numbers subsumed within that range (e.g., 0.5 to 5 includes 1, 1.5, 2, 2.75, 3, 3.80, 4, 5, etc.).

The term “about,” when referring to a value or to an amount of mass, weight, time, volume, concentration, or percentage is meant to encompass variations of ±1% from the specified amount. The term “about XX wt. %” can be taken to means that the wt. % may vary within 1 wt. % of the XX reference numeral unless otherwise specified. That is if XX is 5 wt. %, and thus about 5 wt. % may encompass between 4 wt. % and 6 wt. % unless otherwise described as encompassing a different range.

The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

Moreover, the present disclosure also contemplates that in some aspects, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Weight percent: All weight (and mass) percents expressed herein (unless otherwise indicated) are based on overall composition weight and abbreviated as wt %, %, or wt. %.

### Modified Group I Base Oil for Use in Heat Transfer Fluids

Some aspects, the modification of a Group I base oil, for the purpose of enhancing the thermal conductivity of such Group I base is performed.

In one aspect of the invention, the method of modifying Group I base oil comprises acylation or alkylation of at least one position on an aromatic group of a Group I base oil. In some aspect of the invention acetyl chloride, an aluminum catalyst and a Group I base oil are combined at produce a modified Group I base oil.

In one aspect of the invention, the method of modifying Group I base oil comprises oxidative cracking.

The modified Group I base oil, with improved thermal conductivity characteristics may be combined with any other components typical to a heat transfer fluid or immersive coolant.

In some aspects, the modified Group I base oil is present in the heat transfer fluid or immersive coolant in an amount of about 80 wt % to about 99.9 wt %. Of course a blend of more than one modified Group I base oil that each exhibit improved thermal conductivity characteristics is encompassed according to an aspect of the invention.

### Additives

In some aspects, the heat transfer formulated with at least one additive that may include inorganic corrosion inhibitors, organic corrosion inhibitors, antioxidant, agents, bitterant, hard water suppressant polymers, extreme pressure agents, dispersants, detergents, antioxidants, anti-wear agents, viscosity modifiers, pour point depressants, friction modifiers, anti-foaming agents, demulsifiers, or seal swell agents are used in amounts generally encountered in the art, for example between about 0.01 wt % and about 20 wt %, or between 1 wt % and about 20 wt %.

The heat transfer fluids according to one aspect of the invention may also include additives in the form of an additive package or blends of more than one type of additive. The performance additive package is generally a fully formulated composition, including antioxidant agents, antiwear agents, extreme pressure agents, detergents, dispersants, antifoamer, anti-rust agents, friction modifiers, corrosion inhibitors, and pour point depressants. Additives such as a colorant, dye or fragrance may also be added to the heat transfer fluid.

### EXAMPLES

For the purposes of promoting an understanding of the principles of the present disclosure, reference will now be made to preferred aspects and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

### Example 1: Acylation of Group I Base Oil

Group I base oil typically has about 7% aromatics by analysis of IR as well as 1H NMR. These aromatics exist in many states and probably have alkyl groups attached. Many of these aromatic groups can be acylated or alkylated in at least one position. The process is to modify the base oil by acylation or alkylation, raising its thermal conductivity. Acetyl chloride was employed in a successful lab trial with varying conditions as reported in Table 1. Infrared spectroscopy analysis of the post reaction fluid shows a peak formed in the region of carbonyl stretching, indicating that the acyl group has added to the aromatics in the base oil.

TABLE 1

| Sr. | | | | | |
|---|---|---|---|---|---|
| No. | Reagents | catalyst | solvent | Temperature | Remarks |
| 1. | CH₃COCl | AlCl₃ | DCM | Reflux | Carbonyl stretching |
| | | | | | peak was observed |
| | | | | | in IR spectra. |
| 2. | CH₃COCl | AlCl₃ | Neat | 80° C. | Carbonyl stretching |
| | | | | | peak was observed |
| | | | | | in IR spectra. |
| 3. | CH₃COCl | AlCl₃ | Nitro- | 150° C. | Carbonyl stretching |
| | | | benzene | | peak was observed |
| | | | | | in IR spectra. |
| 4. | CH₃COCl | AlCl₃ | Hexane | 0° C. to | Carbonyl stretching |
| | | | | ambient | peak was observed |
| | | | | temperature | in IR spectra. |
| 5. | CH₃COCl | AlCl₃ | Carbon | 0° C. to | Carbonyl stretching |
| | | | disul- | ambient | peak was observed |
| | | | phide | temperature | in IR spectra. |
| 6. | CH₃COCl | AlCl₃ | Neat | 115° C. | Carbonyl stretching |
| | | | | | peak was observed |
| | | | | | in IR spectra. |

### Example 2: Oxidative Cracking of Group I Base Oil for Enhancing Thermal Conductivity

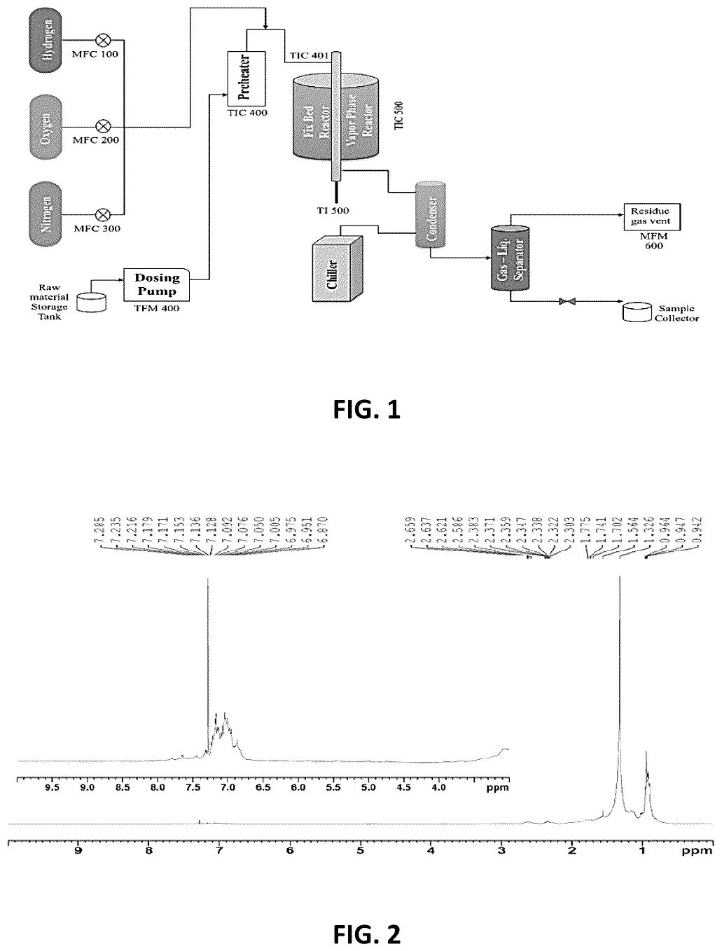

Catalytic oxidative cracking is a combination of heterogeneous and homogeneous reactions wherein the reaction is initiated on the catalyst surface followed by thermal gas phase cracking. Catalysis by metal oxides is one of the most significant subfields of heterogeneous catalysis because it involves most industrially used catalyst families and processes, including those involving silica, alumina, clays, zeolites, TiO2, ZnO, ZrO2, porous and mesoporous metal oxides, polyoxometalates (POMs), the phosphates family (e.g., VPO, FePO4, silica phosphoric acid (SPA), multicomponent mixed oxides (molybdates, antimonates, tungstates etc.), perovskites, hexaaluminates, etc. These thermal gas phase reactions are usually carried out using a fixed-bed reactor (FIG. 1) which are adaptable and simple to scale up. They consist of a long, narrow tube that is positioned vertically inside a furnace, which is maintained at around 400° C. The catalyst bed is fixed in the narrow tube, the base oil and oxygen gas is premixed and then passed over the fixed bed reactor at a fixed flow rate of 1 mL/min. At the exit, the mass is cooled and gets separated into gas and liquid. The gas is exited through the vent and the liquid gets collected as a sample.

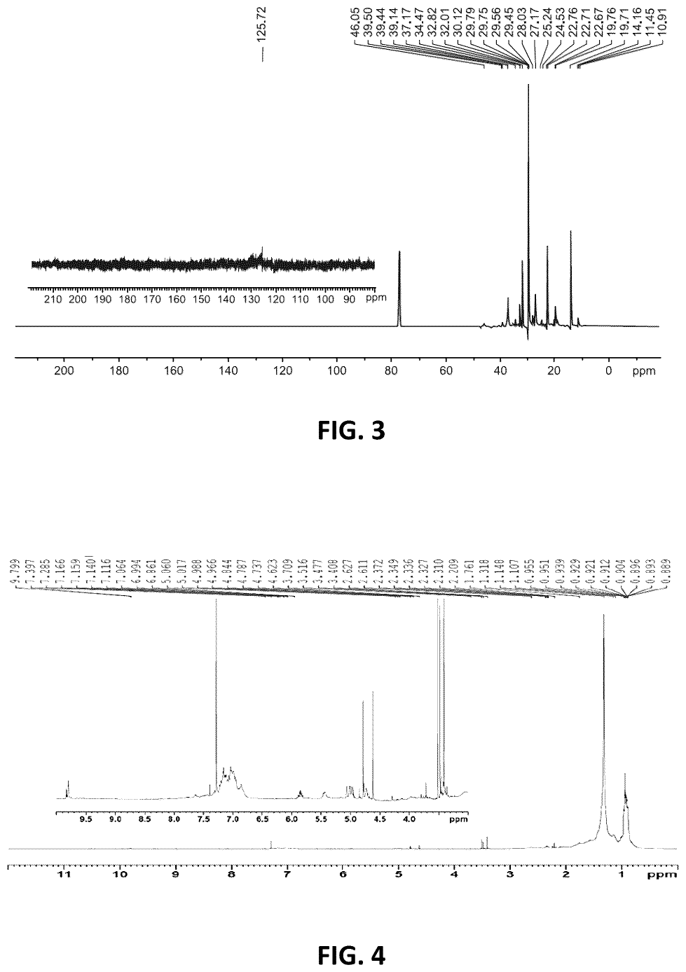

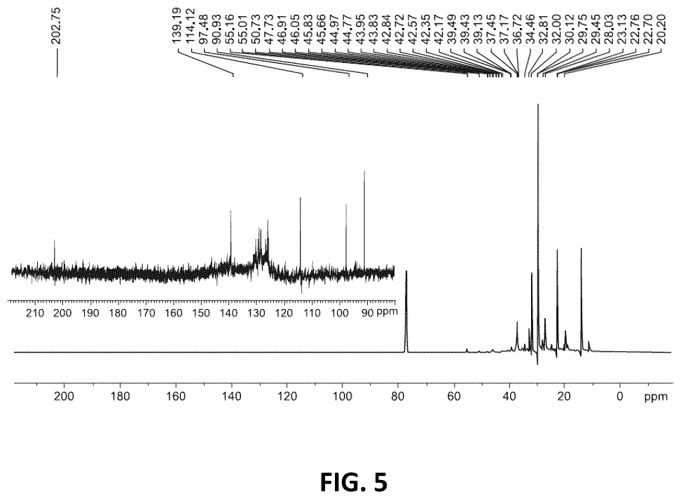

Experiments were conducted with metal oxide, CuO, as a catalyst and oxygen as a reacting gas for oxidation at a flow rate of 40 ml/min. The thermal conductivities of the samples were recorded in range of 0.130-0.131 W/mK against a reference of 0.126 W/mK (Aramco Dura 150). To further improve thermal conductivity and viscosity, combination of catalysts—zeolites and metal oxides—were used. Zeolites are known to break down larger molecules into smaller units. Various combinations of zeolites, e.g., ZSM Y and ZSM 5 and metal oxides, e.g., CuO and Fe₂O₃, were scanned for base oil modification. The samples were characterized by NMR and compared with the Group I base oil (Aramco dura 150) (FIG. 2-FIG. 5).

The results are also summarized in Table 2:

| | | | Thermal | Kinematic | Kinematic |
|---|---|---|---|---|---|
| | | | conduc- | viscosity | viscosity |
| | | | tivity | at 40° C. | at 100° C. |
| No. | R.M. | Catalyst | W/mk. | cSt. | cSt. |
| 1. | Group I Base Oil | | 0.126 | 28.63 | 5.081 |
| | (Aramco dura 150) | | | | |
| 2. | Group I Base Oil | CuO | 0.131 | 18.195 | 3.863 |
| | (Aramco dura 150) | | | | |
| | Exp. 1 | | | | |
| 3. | Group I Base Oil | ZSM-Y + | 0.13 | 22.216 | 4.3147 |
| | (Aramco dura 150) | CuO | | | |
| | Exp. 2 | | | | |
| 4. | Group I Base Oil | ZSM-Y + | 0.13 | 25.909 | 4.6043 |
| | (Aramco dura 150) | Fe₂O₃ | | | |
| | Exp. 3 | | | | |
| 5. | Group I Base Oil | ZSM-5 + | 0.13 | 22.586 | 4.3092 |
| | (Aramco dura 150) | CuO | | | |
| | Exp. 4 | | | | |
| 6. | Group I Base Oil | ZSM-5 + | 0.13 | 24.698 | 4.6022 |
| | (Aramco dura 150) | Fe₂O₃ | | | |
| | Exp. 5 | | | | |

The thermal conductivity of base oil was improved by 4% by thermal oxidative cracking using a catalyst over a fixed bed reactor. The improvement in thermal conductivity was attributed to the presence of oxygen heteroatom in the form of carbonyl group. This was further confirmed by NMR spectroscopy by a signal at 8200 ppm in 13C-NMR and a peak at 89.8 ppm in 1H-HNMR, typical for an aldehyde proton.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

1. A heat transfer fluid comprising a modified Group I base oil, wherein the thermal conductivity of the modified Group I base oil is greater than 0.130 W/mk.

2. The heat transfer fluid of claim 1, wherein the modification of a Group I base oil comprises acylation or alkylation of an aromatic ring with the Group I base oil.

3. The heat transfer fluid of claim 1, wherein the Group I base oil is any Group I.

4. The heat transfer fluid of claim 1, further comprising an additive that is an inorganic corrosion inhibitors, an organic corrosion inhibitors, an antioxidant agent, a bitterant, a hard water suppressant polymers, an extreme pressure agents, a dispersants, a detergents, an antioxidants, an anti-wear agents, a viscosity modifiers, a pour point depressants, a friction modifiers, an anti-foaming agents, or a demulsifier.

5. The heat transfer fluid of claim 4, wherein the additive is a blend of more than one additive.

6. The heat transfer fluid of claim 4, wherein the modified Group I base oil is present in an amount of about 80 wt % to about 99.9 wt % and the additive is present in an amount from about 0.1 wt % to about 20 wt %.

7. A method of modifying a Group I base oil, the method comprising,
applying a Group I base oil to initiation on a catalyst surface to product a catalyzed Group I base oil; followed by
feeding the catalyzed Group I base oil to thermal gas phase cracking, and
collecting a modified Group I base oil in the liquid phase from the thermal gas phase cracking process.

8. The method of claim 7, wherein the catalyst is a metal oxide.

9. The method of claim 8, wherein the catalyst comprises silica, alumina, clays, zeolites, TiO2, ZnO, ZrO2, porous and mesoporous metal oxides, polyoxometalates (POMs), VPO, FePO4, silica phosphoric acid (SPA), molybdates, antimonates, tungstates, perovskites, or hexaaluminates.

10. The method of claim 7, wherein thermal gas phase cracking comprises:
providing a fixed-bed reactor that is a long, narrow tube that is positioned vertically inside a furnace, which is maintained at around 400° C., and the catalyst bed is fixed in the narrow tube,
the catalyzed Group I base oil and oxygen gas is premixed and then them mixture is passed over the fixed bed reactor at a fixed flow rate of 1 mL/min, and
at the exit, the mass is cooled and separated into gas and liquid,
wherein the gas exits through a vent and the liquid gets collected as a sample comprising modified Group I base oil.

11. The method of claim 7, wherein the modified Group I base oil has an improved thermal conductivity of 4% as compared to an unmodified Group I base oil or a thermal conductivity of greater than 0.130 W/mk.
